(19) United States
(12) Patent Application Publication
(10) Pub. No.: US 2013/0011517 A1
(43) Pub. Date: Jan. 10, 2013

(54) DRIED FERMENTED DAIRY PRODUCT CONTAINING A HIGH DENSITY OF LIVING BIFIDOBACTERIA

(76) Inventors: Philippe Teissier, Palaiseau (FR); Pascal Regulier, Guyancourt (FR); Lukas Straka, Paris (FR); Gerardus Coenen, Amsterdam (NL); Carla Buijsse, Wageningen (NL); Yves Credoz, Antony (FR)

(21) Appl. No.: 13/635,330

(22) PCT Filed: Mar. 11, 2011
(86) PCT No.: PCT/EP2011/053752

§ 371 Date: Sep. 14, 2012

(30) Foreign Application Priority Data
Mar. 17, 2010 (IB) PCT/IB2010/001192

(51) Int. Cl. A23C 9/127

(52) U.S. Cl. 426/43; 426/61

(57) ABSTRACT

The present invention concerns a dried fermented dairy product containing living bifidobacteria at a minimal concentration of about 8·10⁷ cfu/g, preferably for at least 3 months at room temperature. The invention also relates to a method for preparing same, and to uses of such a product in the food industry.

The present invention is in the field of food industry, more specifically of dairy industry.

The present invention concerns a dried fermented dairy product containing living bifidobacteria at a minimal concentration of about 8·10⁷ cfu/g.

The invention also relates to a method for preparing same, and to applications of such a product in the food industry.

Probiotics and edible compositions comprising same have become increasingly popular for promoting or maintaining health in mammals, including humans. Typically, probiotics are live bacteria, or active fractions thereof, that provide a health benefit to a host upon consumption.

Food compositions comprising viable probiotics tend to have poor stability. Typically, ready-to-use probiotic-containing compositions are stored and distributed under refrigerated conditions, the compositions being thus fresh products. Alternatively, dried probiotic-containing food concentrates are provided, which either need to be extemporaneously dissolved into suspensions for an immediate consumption, or are consumed directly in powder or capsule form, in order to ensure that a sufficiently high percentage of the bacterial cells contained therein remain viable upon and after consumption.

However, dried bacterial concentrates provide only partial stability benefits. One problem posed by dried probiotic-containing compositions is due to the level of water available in the compositions. Actually, the moderate to relatively high levels of water in the dried compositions provided up to now enable the bacteria contained therein to continue metabolizing during storage. This undesirable metabolism results in the production of acidic metabolites and other side-products, as well as the breakdown and reduction in viability of the bacteria themselves. This confers off-tastes to the compositions and/or alters the organoleptic properties thereof in terms of colours, texture, and the like, the resulting compositions being finally inefficacious or unsuitable for consumption.

In an attempt to remedy to this problem, various solutions have been proposed so far.

Most of these solutions rely upon the use of dried culture medium containing viable bacteria (see, e.g., U.S. patent application published under No. 2005/0100559 on May 12, 2005). Final food compositions are thus obtained by adding to a food preparation, either a bacteria-containing dried, and preferably pre-concentrated, culture medium, or a bacterial dried concentrate obtained upon separating the biomass from the culture medium and drying the recovered biomass. None of these final food compositions are fermented products such as fermented milks or yogurts. And, in many cases, the obtained compositions are not suitable for human consumption (especially when culture media are used).

Alternatively, it has been provided in International patent application No. WO 2007/077401 published on Jul. 12, 2007, a fermented milk or yogurt powder containing very high levels of Streptococcus thermophilus and Lactobacillus bulgaricus, and exhibiting advantageous storage capacities. This powder, showing interesting stability, microbiological and organoleptic characteristics, is suitable for the use of S. thermophilus and L. Bulgaricus. However, the proposed culture and drying conditions are not adapted to the use of other type of lactic acid bacterial strains. In particular, the viability of bifidobacteria would be highly impaired under these conditions.

Despite these advances, long-term storage of dry bacterial compositions, in particular dry compositions containing lactic acid bacteria, is yet far from optimised, especially when delicate bacteria such as bifidobacteria are used.

This problem is addressed for the first time by the present invention which provides a dried composition containing bifidobacteria having exceptional storage and viability capacities. Indeed, as shown below, the Inventors were the first in the art to find out the appropriate conditions for producing a dried fermented dairy product containing a high level of viable bifidobacteria and having a long shelf life given that bifidobacteria are known to be sensitive or delicate bacteria, the viability of which being strongly depending on the pH and the temperature.

An object of the present invention is a dried fermented dairy product containing living bifidobacteria at a minimal concentration of about 8·10⁷ cfu/g.

A “dried fermented dairy product” according to the present invention is edible. It is suitable for mammalian consumption, preferably for human consumption. In particular, the product according to the present invention is a edible dried fermented milk for human consumption.

The term “fermented milk” has the usual meaning attributed thereto in the dairy industry, i.e., a product which is intended for mammal consumption, more particularly for human consumption, and which is derived from acidifying lactic fermentation of an initial dairy substrate or initial dairy mix. Said product may contain secondary ingredients such as fruits, vegetables, sugars, flavors, etc. The term “fermented milk” satisfies strict official guidelines. Reference may in this case be made to the Codex Alimentarius (prepared by the Codex Alimentarius Commission under the aegis of the FAO and ODM content, and published by the Information Division of the FAO, available on-line at http://codexalimentarius.net; see in particular volume 12 of the Codex Alimentarius “Standards for milk and dairy products” and the “Codex Stan A-11(a)-1975” standard now referred to as the Codex Stan 243-2003). In particular, reference may be made to French Law no 88-1203 dated 30 Dec. 1988 relating to fermented milk and yogurt or yoghourt, published in the Official Journal of the French Republic on 31 Dec. 1988. The contents of this Law are incorporated into the present application by reference. It is of note that (i) coagulation of “fermented milk” cannot be carried out by any means other than as a result of the activity of the lactic acid bacteria used; (ii) a “fermented milk” has not undergone any treatment that will remove a constituent element of the dairy mix employed, and in particular it has not had the coagulum drained off; (iii) a “fermented milk” may be supplemented with one or more flavouring extracts, one or more natural flavors and, to a limit of 30 per 100 by weight of finished product, one or more sugars and other foodstuffs endowing a specific taste, for example cereals; (iv) the incorporation of fat an/or protein substituents of non dairy origin is not allowed; (v) the quantity of free lactic acid contained in a fermented milk must not be less than 0.6 grams per 100 grams at the point of sale and the amount of protein material, expressed as the lactic portion, must not be less than that of normal milk.

A “dried” product according to the present invention is, for example, a powdered product or a granulated product.

Preferably, the product according to the present invention contains living bifidobacteria at a minimal concentration of about 8·10⁷ cfu/g for at least about 3 months at room temperature.

Preferably, the water activity (a_{w}) of the product according to the present invention is less than about 0.25. Alternatively or additionally, the pH of the product according to the present invention is from about 4.3 to about 5.8, preferably from about 4.6 to about 5.3.

Preferably, the product according to the present invention is a “shelf-stable product”, that is to say a product having structural and functional properties that do not significantly change or vary during a storage period of the product of at least about 3 months at room temperature. “Room temperature” is preferably from about 15 to about 25° C., yet preferably from about 18° C. to about 23° C. The period “about 3 months at room temperature” thus corresponds to the “minimal storage period” or “minimal shelf life” of the product. Minor changes or variations of the product may be tolerated during storage provided that at least the minimal concentration of living bifidobacteria is maintained during the minimal storage period (in other words, there is no significant loss of viability of the bifidobacteria upon storage). In some embodiments, one or more other features of the product, as disclosed herein, may advantageously be maintained: for example, the water activity a_{w} of less than about 0.25; the pH from about 4.3 to about 5.8; and/or the dry matter content, the protein content, the content of other living lactic acid bacteria such as L. Bulgaricus and/or S. thermophilus and/or Lactococcus lactis, the organoleptic properties, etc. (see below for details).

The product according to the present invention is not a fresh product that requires to be stored under refrigerating conditions (e.g., at about 4° C.).

Unless otherwise indicated, all bacterial concentrations or contents or amounts are expressed in cfu/g of product. Concentrations are thus expressed by reference to a product which is either the final product or another product such as a starting or an intermediate product. The person skilled in the art will clearly and unambiguously identify the product to which reference is made upon reading the present description.

The “minimal bacterial concentration” is the minimal bacterial content all along the minimal shelf life of the dried product. It may be considered as the “final bacterial concentration”, corresponding to the bacterial concentration in the product at the end of the minimal storage period. Preferably, the minimal Bifidobacteria concentration in the product of the present invention is about 10⁸ cfu/g, preferably about 2.5·10⁸ cfu/g, more preferably about 4·10⁸ cfu/g, and yet more preferably about 5·10⁸ cfu/g.

The “maximal bacterial concentration” is the maximal bacterial content all along the minimal shelf life of the dried product. It may correspond to the “initial bacterial concentration”, that is to say the bacterial concentration in the product just once manufactured, at the very beginning of the minimal storage period. Preferably, the maximal Bifidobacteria concentration in the product of the present invention is of about 5·10⁹ cfu/g, preferably of about 2.5·10⁹ cfu/g, and yet preferably of about 10⁹ cfu/g. It may be important not to use Bifidobacteria concentrations higher than those disclosed herein in order to prevent the production of undesirable side-products such as acetic acid that would impart denaturising off-tastes to the resulting food product.

It is worth noting that the product of the invention may also be stored during shorter periods at higher temperature or longer periods than the minimal storage period defined above. For instance, after a storage period of about 1 month at about 35° C., the Bifidobacteria concentration is preferably at least about 3·10⁷ cfu/g. Alternatively, after a storage period of about 5 or even 6 months at about 20° C., the Bifidobacteria concentration may be, for instance, of at least about 3·10⁷ cfu/g, preferably at least about 7·10⁷ cfu/g, yet preferably at least about 1·10⁸ cfu/g. These concentrations thus correspond to the minimal Bifidobacteria concentrations under these specific storage conditions. Preferably, yet under these storage conditions, the Bifidobacteria concentration is no more than about 5·10⁸ cfu/g, preferably no more than about 10⁸ cfu/g, yet preferably no more than about 8·10⁷ cfu/g, corresponding thus to the maximal Bifidobacteria concentrations under these conditions.

The product according to the present invention contains living bifidobacteria. Said bifidobacteria are preferably selected from Bifidobacterium bifidum, Bifidobacterium infantis, Bifidobacterium animalis, especially Bifidobacterium animalis subsp. lactis, Bifidobacterium breve, Bifidobacterium longum, and combinations thereof. Advantageously, said bifidobacteria comprise at least Bifidobacterium animalis subsp. lactis, preferably strain I-2494 deposited on Jun. 20, 2000, at the Collection Nationale de Cultures des Microorganismes (CNCM), Institut Pasteur, 25 rue du Docteur Roux, 75724 PARIS cedex 15, France.

Interestingly, the product of the present invention may further comprise other living lactic acid bacteria, especially lactic acid bacteria selected from Lactobacillus sp., Streptococcus sp., Lactococcus sp., and combinations thereof. More particularly, said living lactic acid bacteria are selected from Lactobacillus bulgaricus, Lactobacillus acidophilus, Lactobacillus paracasei, Lactobacillus pentosus, Lactobacillus helveticus, Lactobacillus reuteri, Lactobacillus plantarum, Lactobacillus bifidus, Streptococcus thermophilus, Streptococcus lactis, Streptococcus raffinolactis, Streptococcus cremoris, Lactococcus lactis, and combinations thereof. Preferred living lactic acid bacteria to be used in the present invention are selected from Lactobacillus bulgaricus, Streptococcus thermophilus, Lactococcus lactis, and combinations thereof. In this case, the product according to the invention may contain:
a concentration of living L. bulgaricus from about 3·10⁶ cfu/g to about 3·10⁹ cfu/g; and/or
a concentration of living S. thermophilus from about 10⁷ cfu/g to about 3·10⁸ cfu/g; and/or
a concentration of living L. lactis from about 5·10⁶ cfu/g to about 5·10⁸ cfu/g.

Advantageously, if the fermented product of the present invention contains such a concentration of L. bulgaricus and S. thermophilus, it fulfills the specifications for a “yogurt” (see the Codex Alimentarius available on line at http://codexalimentarius.net, especially the CODEX STAN 243-2003 standard). Indeed, not all the fermented products containing these bacteria can be called yogurts, but only those wherein living L. bulgaricus and S. thermophilus are present at least at about 1·10⁷ cfu/g.

Preferably, the water activity a_{w} of the product according to the present invention is less than about 0.25, yet preferably less than about 0.2. The term “water activity (a_{w})” refers to water in food which is not bound to food molecules and which thus can support the growth of microorganisms (bacteria, yeasts and moulds (fungi)), including pathogenic microorganisms. The a_{w} is preferably measured at ambient temperature such as 20-26° C., for example at about 25° C.

Preferably, the pH of the product according to the invention is from about 4.3 to about 5.8, more preferably from about 4.6 to about 5.3. Bifidobacteria are generally sensitive to acidity. Thus, the Inventors paid high attention to pH during conception of the present invention.

It was indeed a challenge for the Inventors to provide a dried fermented Bifidobacterium-containing food product wherein not only microbial poisoning but also loss of Bifidobacteria viability are prevented during storage at room temperature. To this end, after considerable search efforts, the Inventors achieved to specify appropriate acidity level (pH) and a_{w} for obtaining a satisfying product as disclosed in the context of the present invention.

Preferably, the product according to the present invention has a dry matter (DM) content from about 94 to about 98%, yet preferably from about 95% to about 97%. Preferably, the fermented dairy mix that will give the product according to the invention upon drying has a DM content from about 10 to about 30%, yet preferably from about 15% to about 25%, and more preferably of about 24%. Above about 30%, lactic acid bacteria, including bifidobacteria, have high difficulties to grow. Also, such a DM content is required to be able to practice appropriate drying step(s).

Typically, the DM content corresponds to the mass of residual material measured after placing the product at 105° C. for 17 hours, with respect to the initial volume or to the initial mass of the product. The DM content can be measured directly, i.e., by placing the product the DM content of which is to be determined at 105° C. for 17 hours and measuring the mass of residual material which contained the initial volume of the treated product. Alternatively, a DM content may be measured indirectly, i.e., by measuring a parameter of the product from which the DM content may be deduced or estimated. As an example, the skilled person may measure the density of the product at a given temperature (for example at 45° C.) and deduce there from the corresponding DM content, for example using a chart or a correspondence curve already drawn up by the skilled person, to deduce, from the density measured at the given temperature, the DM content corresponding thereto for the product under consideration. For instance, with respect to an initial dairy mix used as a starting material for preparing a fermented dairy product according to the present invention, indirect measurements such as densitometry are usually preferred as they can be carried out faster than the direct method. A conventional initial dairy mix has a DM content of the order of 10-20%, for example 11-13%. A fermented milk obtained by lactic fermentation of such a conventional initial dairy mix has a DM content which is not substantially different from that of the initial dairy mix, i.e., a conventional DM content of the order of 10-20%.

Preferably, the viscosity of the fermented dairy mix that will give the product according to the invention upon drying is from about 50 mPa·s to about 250 mPa·s, yet preferably from about 50 mPa·s to about 400 mPa·s.

To obtain the required viscosity, the fermented dairy mix is preferably shorn using, for example, a dynamic smoothing equipment with a high peripheral velocity (minimum 30 m/s), or using a homogeniser with a minimum pressure at 150 bars.

The measurement of viscosity is advantageously done at 10° C. with a Rheomat and following parameters: 1 1/64 s- 1/10 s.

Preferably, in the fermented dairy mix that will give the product according to the invention upon drying, the protein content is from about 3 to about 7%, yet preferably from about 3.5 to 6.2%.

Preferably, the product according to the present invention further comprises one or more food additives selected from:

protecting agents for bifidobacteria;

sweeteners or sugars;

growth-promoting nutrients for bifidobacteria;

dispersing agents; and

combinations thereof.

Preferably, the product of the invention comprises yeast extract, acacia gum, pectin, cellulose, and at least one sugar selected from saccharose, fructose, lactose, and glucose.

“Protecting agents for bifidobacteria” are food-acceptable agents capable of favoring the survival of bifidobacteria. Such agents preferably maintain a sufficiently high concentration of living bifidobacteria in the product, all along its manufacturing (especially the drying step(s)) and storing. Appropriate agents may be selected from acacia gum, cellulose, and threalose.

“Sweeteners or sugars” are food-acceptable carbohydrate sweeteners that may be natural or artificial, no or low calorie sweeteners. Preferred examples of appropriate sugars are sucrose, fructose, lactose, and glucose.

“Growth-promoting nutrients for bifidobacteria” are food-acceptable agents capable of improving the growth of bifidobacteria by, e.g., being metabolized by bifidobacteria. For instance, one can cite acacia gum and yeast extract.

“Dispersing agents or dispersants” are food-acceptable agents that are capable of enhancing recovering of a homogeneous liquid composition upon dissolution of the dried product of the invention into an appropriate liquid (corresponding to the reconstitution of a liquid composition). These agents will advantageously prevent milk proteins from precipitating upon reconstitution of an acidic liquid composition. Suitable dispersants can be selected from pectin, lecithin, cellulose, and carraghenans.

One or more other food additives may be added to enhance the properties of the product according to the invention. Such other food additives may be selected from vitamins (e.g., vitamin A, B1, B2, B6, B12, C, D, E, K, folic acid, etc.), enzymes, plasticizers, colouring agents (pigments, dyes, etc.), flavouring agents (e.g., fruit flavours), anti-oxidants, buffering agents, lubricants (e.g., vegetable oils), stabilizers, and combinations thereof. If need be, the skilled artisan will be able to choose appropriate food additives among all the well-known food additives and excipients available on the market.

Preferably, the dairy product according to the present invention contains no starch, starch hydrolysate, or gelatinized material.

A method or process for preparing a dried fermented dairy product as described herein is also an object of the present invention.

More particularly, the present invention relates to a method for preparing a dried fermented dairy product having a high density of living bifidobacteria, comprising:

a) providing an initial dairy mix;
b) optionally, adding to said initial dairy mix one or more additives selected from:

protecting agents for bifidobacteria;

sweeteners or sugars;

growth-promoting nutrients for bifidobacteria;

dispersing agents; and

combinations thereof;

c) inoculating said initial dairy mix or the mix obtained in step b) with living bifidobacteria at a maximal concentration of about 10⁹ cfu/g;
d) fermenting the inoculated mix obtained in step c) at a temperature from about 35° C. to about 39° C., in particular from about 36° C. to about 37° C., during a period of time from about 4 to about 6 hours, and at a pH from about 4.3 to about 5.8;
e) primary drying the fermented mix obtained in step d) in a spray-drying chamber having an air inlet temperature from about 120 to about 145° C. and an air outlet temperature from about 50 to about 70° C., for a period of time of about 30 to about 50 sec, at a feed temperature less than about 40° C.;
f) optionally, secondary drying the resulting product, preferably on a fluidized bed;
g) recovering said product;
h) optionally, packaging the product obtained in step g); and
i) optionally, shelf-storing the product obtained in step g) or h), preferably for up to about 3 months at room temperature.

Preferably, the product is stored about 3 months at room temperature under low oxygen conditions (e.g., nitrogen).

Preferably, the product according to the present invention as described above is obtained from an initial dairy mix using this method. Thus, all the definitions and preferred features described above with respect to the dried fermented dairy product are applicable to the present method.

In particular, bifidobacteria are selected from Bifidobacterium bifidum, Bifidobacterium infantis, Bifidobacterium animalis, especially Bifidobacterium animalis subsp. lactis, Bifidobacterium breve, Bifidobacterium longum, and combinations thereof. Advantageously, said bifidobacteria comprise at least Bifidobacterium animalis subsp. lactis, preferably strain I-2494 deposited on Jun. 20, 2000 at the CNCM.

The term “initial dairy mix” means a white mass as conventionally used in the dairy industry. It is usually designated as a “milk” which is a composition consisting essentially of milk and/or milk components. Milk is typically from animal origin and it may be whole milk, skimmed milk, semi-skimmed milk, milk concentrate, fresh milk, milk powder, reconstituted milk, milk enriched with milk components and/or food additives, etc. Lactic fermentation of said “initial dairy mix” by bifidobacteria results in a product which is preferably intended for human consumption, and more particularly which can be designated as a fermented milk.

Importantly, the “initial dairy mix” according to the present invention is not a bacterial culture medium which can be defined as a medium favouring and/or stimulating the growth of lactic acid bacteria. Indeed, a culture medium will enable to obtain a bacterial inoculum that may lead, upon appropriate separation, to a concentrated bacterial biomass, said inoculum or said concentrated biomass being useful for addition to a food product such as a yet fermented food product (having thus been fermented by other lactic acid bacteria than those contained in the inoculum or the concentrated biomass). On the contrary, the initial dairy mix used in the present invention is a starting material that will be transformed upon lactic fermentation in order to obtain a product suitable for mammalian (preferably human) consumption (if necessary, after reconstitution in a liquid, especially if the product is dried). Actually, the initial dairy mix will undergo a fermentation step by the lactic acid bacteria that are added thereto at the beginning of the manufacturing process. No other bacteria will then be added during the process. This means that all the materials present during the fermentation step will be contained in the final product.

Preferably, the initial dairy mix comprises one or more ingredients selected from:

milk;

cream;

skimmed milk powder; and

combinations thereof.

Many compounds which may be added to a culture medium to stimulate and/or encourage the growth of lactic acid bacteria cannot be added to an “initial dairy mix” in order to obtain a fermented dairy product according to the invention. This is in particular the case with many surfactants and/or emulsifying agents and/or solubilising agents and/or detergents, such a polyoxyethylene-sorbitan-20-monooleate (also known as polysorbate 80 or Tween 80).

Preferably, the mix obtained in step b) has the following formula (Table 1):

TABLE 1

| Ingredients | % wt |
|---|---|
| Milk | 76.19 |
| Cream | 7.03 |
| Skimmed milk powder | 10.26 |
| Sugar | 4.00 |
| Acacia gum | 2.00 |
| Yeast extract | 0.02 |
| Pectin and cellulose | 0.50 |

Preferably, in step c), the initial dairy mix or the mix obtained in step b) is inoculated with living bifidobacteria at a maximal concentration of about 5·10⁸ cfu/g, preferably about 2.5·10⁸ cfu/g.

Preferably, other living lactic acid bacteria are also added in step c), said lactic acid bacteria being advantageously selected from Lactobacillus sp., Streptococcus sp., Lactococcus sp., and combinations thereof.

In the method of the invention, massive inoculation of the dairy mix is carried out. This massive inoculation has the effect of resulting in a very limited growth of biomass. The inventors have demonstrated that, while the bacterial cell growth is considerably reduced, the fermenting activity is unexpectedly entirely equivalent or even better than that which may be observed during conventional milk fermentation. The invention thus proposes and allows cell growth to be decoupled from fermenting activity.

As mentioned above, no further living bacteria, especially lactic acid bacteria, are added after step d).

Lactic fermentation (step d)) is carried out using techniques which are known to the skilled person, so as to obtain a fermented dairy product which can be a fermented milk.

When reference is made to a “lactic fermentation”, this means an acidifying lactic fermentation which results in milk coagulation and acidification following the production of lactic acid which may be accompanied by the production of other acids, carbon dioxide and various substances such as exopolysaccharides (EPS) or aromatic substances, for example diacetyl and acetaldehyde.

Here, during fermentation (step d)), concomitant acidification of the inoculated mix and bacterial adaptation to physico-chemical stresses (especially, acidification of the medium and subsequent drying conditions) are performed. This will advantageously improve shelf life stability of the resulting product. The fermentation conditions have to be controlled in order to: (i) optimise concomitant medium acidification and bacterial adaptation; (ii) avoid substantial loss of Bifidobacteria viability (while not favouring and/or stimulating bacterial growth); and (iii) prevent the bacteria from producing undesirable side-products such as acetic acid. The inoculated mix is thus maintained under conditions, in particular temperature conditions, which are favourable to the fermenting activity of bifidobacteria until a fermented dairy product (preferably a fermented milk) is obtained.

Accordingly, for the fermentation step d):

a preferred temperature is about 36.5° C.; and/or

a preferred time is about 5 hours; and/or

a preferred pH is about 4.8.

In the method of the present invention, mild but very extensive powderizing is carried out and is combined with bulk inoculation of the initial dairy mix to obtain the expected living bifidobacterial concentrations. This is achieved without it being necessary to add lactic acid bacteria which would not participate in lactic fermentation and/or which would be added post-inoculation, and without it being necessary to concentrate the fermented mass.

The method according to the present invention does not comprise any step consisting of collecting or concentrating or separating the bacterial biomass. In the method of the invention, the bacterial biomass is not separated and resuspended.

Powderizing (step e) and optionally step f)) is carried out until a powder of fermented dairy product which has an a_{w} of less than about 0.25 is obtained, while ensuring that the powderizing conditions, in particular the temperature conditions applied, are sufficiently favourable to the survival of bifidobacteria.

Regarding step e), preferred conditions of the primary drying of the fermented mix obtained in step d) in the spray-drying chamber are as follows:
an air inlet temperature from about 120 to about 140° C., preferably from about 120 to about 138° C., yet preferably from about 120 to about 135° C.; and/or
an air outlet temperature from about 55 to about 65° C., preferably from about 59 to about 63° C.; and/or
the primary drying is performed for a period of time of about 38 to about 45 s, preferably of about 41 s; and/or
the feed temperature is between 3 and 40° C. depending on the texture of the product, preferably less than about 10° C., more preferably from about 6 to about 9° C., and yet more preferably of about 8° C.; and/or
the temperature of the product in the spray-drying chamber is from about 30 to about 45° C., preferably from about 35 to about 43° C., yet preferably from about 38 to about 42° C., and more preferably of about 41.5° C.

The Bifidobacteria viability is known to start decreasing at a temperature of about 43° C. This is the reason why the temperature will be carefully controlled during drying of the product.

Water activity may still be too high after step e). If the desired a_{w} value has not yet been reached after step e), a further drying step f) is recommended in order to lower said a_{w} so as to obtain the desired a_{w} value and to extend the shelf life of the product at room temperature. The drying step can be done by a fluidized bed or other techniques such as freeze drying, putting under low moisture atmosphere flow, mixing with chemical edible water binders, diluting in dry matrix, and the like. If a fluidized bed is used in step f) to secondarily dry the product obtained in step e), it is preferably such as Gea Niro, Anhydro or Glatt type, and it is used after the spray-drying chamber used in step e). It may be located at the bottom of the spray-drying chamber and optionally followed by a cooling of the resulting powder. The following Table 2 gives illustrative a_{w} values for a product according to the present invention:

TABLE 2
Aw (—)

| After spray drying (step e)) | After secondary drying (step f)) |
|---|---|
| 0.351 | 0.171 |
| 0.288 | 0.190 |
| 0.264 | 0.190 |

Appropriate fluidized bed conditions are advantageously set up depending on the water activity of the product at the outlet of the spray-drying chamber. For instance, for a water activity from 0.27 to about 0.20, appropriate conditions may be:
a temperature from about 30 to about 45° C., preferably from about 32 to about 40° C., yet preferably from about 32 to about 35° C.; and/or
a drying time from about 2 min to about 120 min, preferably from about 10 min to about 60 min, yet preferably from about 15 min to about 30 min.

Preferably, the concentration of bifidobacteria in the product obtained in step i) is the minimal Bifidobacteria concentration defined above. It is at least of about 8·10⁷ cfu/g, preferably of about 10⁸ cfu/g, more preferably of about 2.5·10⁸ cfu/g, yet more preferably of about 4·10⁸ cfu/g, and even more preferably of about 5·10⁸ cfu/g.

When other lactic acid bacteria than bifidobacteria are added in step c), preferred embodiments are as follows:
L. bulgaricus is added in step c) at a concentration from about 10⁵ cfu/g to about 2·10⁷ cfu/g; and/or the product obtained in step i) has a L. bulgaricus concentration from about 3·10⁶ cfu/g to about 3·10⁹ cfu/g; and/or
S. thermophilus is added in step c) at a concentration from about 2·10⁵ cfu/g to about 5·10⁷ cfu/g; and/or the product obtained in step i) has a S. thermophilus concentration from about 10⁷ cfu/g to about 3·10⁸ cfu/g; and/or
L. lactis is added in step c) at a concentration from about 3·10⁶ cfu/g to about 2·10⁸ cfu/g; and/or the product obtained in step i) has a L. lactis concentration from about 5·10⁶ cfu/g to about 5·10⁸-cfu/g.

Preferably, the product obtained in step g) has at least one of the following features:
a water activity a_{w} of less than about 0.25, preferably of less than about 0.2; and/or
a dry matter content from about 94 to about 98%, preferably from about 95 to about 97%; and/or
a pH from about 4.3 to about 5.8, preferably from about 4.6 to about 5.3, yet preferably from about 4.8 to about 5.3.

Preferably, the method according to the present invention further comprises, before step h) or i), a step of mixing the product obtained in step g) with a flavoured edible powder, such as a fruit juice concentrated powder, a vegetable juice concentrated powder, a fruit compote or a fruit puree.

By “fruit juice”, it is meant herein fruit juice, fruit juice concentrate or reconstituted fruit juice from fruit juice concentrate. For example, fruits may be selected from pear, strawberry, peach, pineapple, grape, apple, apricot, orange, banana, mango, cherry, plum, prune, blackberry, bilberry, raspberry, grapefruit, guava, kiwi fruit, passion fruit, papaya, lemon, quince, litchi, pomegranate, melon, etc.

By “vegetable juice”, it is meant herein vegetable juice, vegetable juice concentrate or reconstituted vegetable juice from vegetable juice concentrate. For example, vegetable may be selected from soya, rice, oat, quinoa, chestnut, almond, nut, etc.

Another object of the present invention is a dried fermented dairy product having a high density of living bifidobacteria that is obtainable by a method as described above.

Thus, the dairy product according to the present invention is a fermented product, preferably a fermented milk, with a high concentration of bifidobacteria in the viable or live form, without the need to add other lactic acid bacteria which would not participate in lactic fermentation and/or which would be added subsequently to inoculation, and without the need to concentrate the fermented mass.

Yet another object of the present invention is a flavoured powder having a high density of living bifidobacteria, which comprises mixing a dried fermented dairy product as described above and a flavoured edible powder, such as a fruit juice concentrated powder or a vegetable juice concentrated powder.

The particle size of the dried fermented dairy product or of the flavoured powder according to the present invention will advantageously adapted to the intended use thereof. For instance, one may choose a particle size from about 10 to about 500 μm for a single particle, which is optionally agglomerated or granulated to larger particles.

A further object of the present invention is a sealed container comprising a dried fermented dairy product or a flavoured powder as described above.

Preferably, such a container is selected from a jar, a sachet, a capsule, and a can. Examples of possible embodiments of a container according to the present invention are: low oxygen atmosphere, protection against light and/or moisture and/or gas transition with the environment.

Other objects of the present invention are a dried fermented dairy product or a flavoured powder as described above, for use as:
a probiotic; and/or
an edible coating or filling.

A “coating” is an edible composition to be applied onto a food product. It may be applied, e.g., uniformly all around the food product, or on one or more sides or surfaces thereof, or as one or more discrete regions or plots.

A “filling” is an edible composition to be applied into a food product. It may be applied, e.g., in “sandwich” between two or more pieces of a food product, or as an internal core in a multi-layered food product.

Another object of the present invention is a method for preparing an edible composition having a high density of living bifidobacteria, comprising:

a) adding an edible preparation to a dried fermented dairy product or a flavoured powder as described above; and
b) recovering said composition.

For example, an edible preparation for use in step a) may contain chocolate and/or other flavourings such as fruit flavourings.

The edible preparation used in step a) and/or the edible composition recovered in step b) may be a coating or a filling as disclosed above. Alternatively or additionally, it may be:

semi-liquid such as a fruit puree, a jam or a yogurt; or

liquid, such as a water, a milk, a fruit juice or a vegetable juice.

The edible composition having a high density of living bifidobacteria that is obtainable by the foregoing method is also an object of the present invention.

Another object of the present invention is a method for preparing a foodstuff having a high density of living bifidobacteria, comprising:

a) coating or filling a foodstuff preparation with a dried fermented dairy product or a flavoured powder or an edible composition as described above; and
b) recovering said foodstuff.

Yet another object of the present invention is a foodstuff having a high density of living bifidobacteria obtainable by such a method.

Preferably, the foodstuff according to the present invention is selected from crackers, cereal bars, snacks, cakes, and biscuits.

Non-limiting embodiments and advantages of the present invention are shown in the following examples.

### EXAMPLES

### 1) Example 1

### Preparation of a Dried Fermented Dairy Product According To the Present Invention

The product was prepared by spray-drying a fermented white mass (or fermented mix).

An example of initial dairy mix formula is described above (see Table 1).

TABLE 3
white mass formula before inoculation

| Ingredient | Quantity (kg) |
|---|---|
| SKIM MILK POWDER | 10.11 |
| SKIMMED MILK | 76.29 |
| CREAM | 7.18 |
| SUGAR | 4.00 |
| ACACIA GUM | 2.00 |
| YEAST EXTRACT | 0.02 |
| CELLULOSE GUM | 0.40 |
| MIX | 100.00 |

TABLE 4
white mass formula after inoculation

| | Quantity |
|---|---|
| Composition | (kg) |
| MIX | 99.40 |
| CULTURE | 0.60 |
| WM for spray-drying | 100.00 |

Other characteristics of the white mass (WM) before fermentation were:
protein content: 6.2%;
fat content: 3%.

The fermentation was stopped at pH 4.8 after 5 h 30 min, by cooling the resulting mix at a temperature below 20° C.

In all experiments described herein, the number of bifidobacteria and the water activity were determined on the resulting product using methods well-known to the person skilled in the art.

Analyses after spray drying+fluidized bed, the product having been stored <7 days at 20° C.:

a) Bifidobacterium count: 1.9E+09
b) Water activity: 0.17±0.03.

### 2) Time Stability of the Bifidobacteria in a Product Prepared According to Example 1

Analyses were performed within a 6-month storage period at 20° C.:

TABLE 5
a): Bifidobacterium count

| | | Bifidobacterium |
|---|---|---|
| Time | | content |
| <7 | days | 1.9E+09 |
| 3 | months | 7.4E+08 |
| 6 | months | 1.6E+08 |

TABLE 6
b): Water activity

| | Water activity |
|---|---|
| Time | (a_{w}) |
| 3 months | 0.24 ± 0.03 |
| 6 months | 0.26 ± 0.03 |

### 3) Comparative Example 2

### Time Stability of the Bifidobacteria in a Product not Prepared According to the Present Invention

The Inventors have selected the parameters as disclosed herein (product composition and method for preparing same) for achieving Bifidobacterium stability in the dried fermented dairy product.

If a standard method using other, arbitrary parameters are used (for instance, conventional drying conditions such as: an air inlet temperature in the spray-drying chamber from about 189 to about 195° C. and an air outlet temperature from about 89 to about 95° C.), only low concentration of living bifidobacteria can be achieved in the resulting product.

Below is given an example of a Bifidobacterium count obtained after a conventional drying (see e.g., the conditions above which are standard for producing milk-based powder). The dried product has been stored less than 7 days at 20° C.
Bifidobacterium count: <10E+03.

1-18. (canceled)

19. A dried fermented dairy product containing living bifidobacteria at a minimal concentration of about 8·10⁷ cfu/g.

20. The product according to claim 19, having a minimal concentration of about 8·10⁷ cfu/g for at least 3 months at room temperature.

21. The product according to claim 19, having a water activity a_{w} of less than about 0.25 and/or a pH from about 4.3 to about 5.8.

22. The product according to claim 19, having a maximal concentration of bifidobacteria of about 5·10⁹ cfu/g.

23. The product according to claim 19, having a maximal concentration of bifidobacteria of about 2.5·10⁹ cfu/g.

24. The product according to claim 19, having a maximal concentration of bifidobacteria of about 10⁹ cfu/g.

25. The product according to claim 19, wherein said bifidobacteria are selected from Bifidobacterium bifidum, Bifidobacterium infantis, Bifidobacterium animalis, and combinations thereof.

26. The product according to claim 19, wherein said bifidobacteria are selected from Bifidobacterium animalis subsp. lactis, Bifidobacterium breve, Bifidobacterium longum, and combinations thereof.

27. The product according to claim 19, further comprising other living lactic acid bacteria.

28. The product according to claim 19, further comprising other living lactic acid bacteria selected from Lactobacillus sp., Streptococcus sp., Lactococcus sp., and combinations thereof.

29. The product according to claim 19, further comprising other living lactic acid bacteria selected from Lactobacillus bulgaricus, Streptococcus thermophilus, Lactococcus lactis, and combinations thereof.

30. The product according to claim 19, further comprising other living lactic acid bacteria and, having a concentration of Lactobacillus bulgaricus from about 3·10⁶ cfu/g to about 3·10⁹ cfu/g; and/or a concentration of Streptococcus thermophilus from about 10⁷ cfu/g to about 3·10⁸ cfu/g; and/or a concentration of Lactococcus lactis from about 5·10⁶ cfu/g to about 5·10⁸ cfu/g.

31. The product according to claim 19, having a dry matter content from about 94 to about 98%.

32. The product according to claim 19, having a dry matter content from about 95% to about 97%.

33. A method for preparing a dried fermented dairy product having a high density of living bifidobacteria, comprising:
a) providing an initial dairy mix;
b) optionally, adding to said initial dairy mix one or more additives selected from:
protecting agents for bifidobacteria;
sweeteners or sugars;
growth-promoting nutrients for bifidobacteria;
dispersing agents; and
combinations thereof;
c) inoculating said initial dairy mix or the mix obtained in step b) with living bifidobacteria at a maximal concentration of about 10⁹ cfu/g;
d) fermenting the inoculated mix obtained in step c) at a temperature from about 35 to about 39, in particular from about 36° C. to about 37° C., during a period of time from about 4 to about 6 hours, and at a pH from about 4.3 to about 5.8;
e) primary drying the fermented mix obtained in step d) in a spray-drying chamber having an air inlet temperature from about 120 to about 145° C. and an air outlet temperature from about 50 to about 70° C., for a period of time of about 30 to about 50 sec, at a feed temperature less than about 40° C.;
f) optionally, secondary drying the resulting product, preferably on a fluidized bed;
g) recovering said product;
h) optionally, packaging the product obtained in step g); and
i) optionally, shelf-storing the product obtained in step g) or h), preferably for up to about 3 months at room temperature.

34. The method according to claim 33, wherein said initial dairy mix comprises one or more ingredients selected from:
milk;
cream;
skimmed milk powder; and
combinations thereof.

35. The method according to claim 33, wherein other living lactic acid bacteria are added in step c).

36. The method according to claim 33, wherein other living lactic acid bacteria are added in step c, said lactic acid bacteria being selected from Lactobacillus sp., Streptococcus sp., Lactococcus sp., and combinations thereof.

37. A flavoured powder having a high density of living bifidobacteria, comprising mixing a product according to claim 19 and a flavoured edible powder.

38. A flavoured powder having a high density of living bifidobacteria, comprising mixing a product according to claim 19 and a flavoured edible powder, wherein the flavoured edible powder consists in a fruit juice concentrated powder or a vegetable juice concentrated powder.

39. A dried fermented dairy product having a high density of living bifidobacteria obtainable by a method according to claim 33.

40. A sealed container comprising a product according to claim 19 or 39, or a powder according to claim 37 or 38.

41. A method for preparing an edible composition having a high density of living bifidobacteria, comprising:
a) adding an edible preparation to a product according to claim 19 or 39, or a powder according to claim 37 or 38; and
b) recovering said composition.

42. An edible composition having a high density of living bifidobacteria obtainable by a method according to claim 41.

43. A method for preparing a foodstuff having a high density of living bifidobacteria, comprising:
a) coating or filling a foodstuff preparation with a product according to claim 19 or 39, or a powder according to claim 37 or 38; and
b) recovering said foodstuff.

44. A foodstuff having a high density of living bifidobacteria obtainable by a method according to claim 43.
